(19) United States
(12) Patent Application Publication
(10) Pub. No.: US 2012/0186028 A1
(43) Pub. Date: Jul. 26, 2012

(54) Leather Cleaner

(76) Inventor: Jibril RASHID, Washington, DC (US)

(21) Appl. No.: 13/357,103

(22) Filed: Jan. 24, 2012

Related U.S. Application Data
(60) Provisional application No. 61/435,717, filed on Jan. 24, 2011.

(51) Int. Cl. C11D 7/60; D06L 1/00

(52) U.S. Cl. 8/137; 510/275

(57) ABSTRACT

Liquid leather cleaner is used for shoes, handbags, and many other leather products. The liquid solution is placed in a plastic bottle with a label attached to the bottle. The bottle also comprises a spray unit and a cap. Sodium hydroxide, Ethylbenzyl, and Ammonium Chloride are the ingredients of the leather cleaning solution. As for the method of using the product, shake the leather cleaning bottle before it is sprayed on the surface to be cleaned. Then a clean cotton cloth or paper towel is used to wipe dry.

The current application claims a priority to the U.S. Provisional Patent application Ser. No. 61/435,717 filed on Jan. 24, 2011.

### FIELD OF THE INVENTION

The present invention relates generally to a composition for cleaning leather. More particularly, the present invention is a liquid leather cleaner formulation intended for but not limited to shoes and car seats.

### BACKGROUND OF THE INVENTION

Leather is widely used in many different industries such as but not limited to shoes, articles of clothing, accessories, book covers, and sports equipment. Leather is a versatile material which can be used for insulation during varying weather, ventilation and evaporation, and its durability and flexibility. However, leather's fibers break down over time, causing changes in its consistency and losing its strength and durability. Conditioners and other treatments used to cure leather have been discouraged because, if done incorrectly, have many disadvantages. If done correctly, these conditioners have little positive impact to the preservation of the leather. It is therefore an object of the present invention to introduce a formulation for cleaning and conditioning leather.

### BRIEF DESCRIPTION OF THE DRAWINGS

FIG. 1 is view of the system for leather cleaning solution.

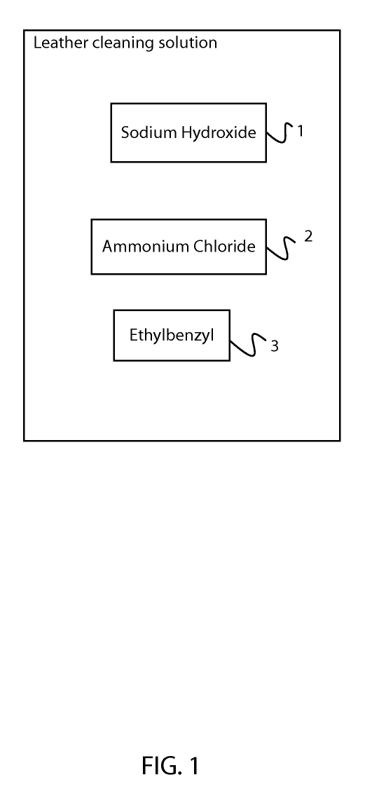

### DETAIL DESCRIPTIONS OF THE INVENTION

All illustrations of the drawings are for the purpose of describing selected versions of the present invention and are not intended to limit the scope of the present invention.

The present invention, herein referred is liquid leather cleaner for a plurality of leather-bound items, including but not limited to shoes and car seats. The liquid leather cleaner is intended to be placed in 4 oz. bottles with labels attached to the bottles. The label list the contents of the liquid stored therein. The present invention is a formulation or composition of ingredients used to actively clean, condition, deodorize, and revive leather whose natural fibers have broken down with age and wear. Furthermore, leather cleaning solution intends to clean leather materials without damaging its initial colors.

The present invention comprises Sodium Hydroxide 1, Ammonium Chloride 2, and Ethylbenzyl 3 as the active ingredients. The above ingredients are mixed together to prepare a liquid leather cleaning solution which is stored in a bottle.

The bottle comprises a spray unit, a cap, and a label. The bottle is designed as a spray bottle so the users will be able to use the product with a minimum of wastage. Each bottle is filled with 4 oz of the leather cleaning solution. The bottle is made out of white colored recyclable plastic materials. The spray unit is manufactured with black colored recyclable plastic materials and the cap is made out of clear plastic. All of the components in the bottle are manufactured out of plastic material because of the Sodium Hydroxide 1 in the leather cleaning solution. The Sodium Hydroxide 1 has some corrosive properties within the material so any kind of metal components in the bottle will be useless due to the corrosive reaction between the material and the leather cleaning solution.

The label comprises a plurality of graphics, a product logo, a barcode, a safety instructions section, a product ingredients section, a plurality of product properties, a product directions section, and a product volume. The plurality of graphics consists of aesthetic pleasing pictures like a basketball, leather shoes, or hand bag. Most of the graphics are displayed in the center of the label. Background of the label comprises graphics of a basketball court. The product logo also displayed in the center of the label. The barcode is located in the bottom right corner of the label. The safety instruction section is positioned in the top left hand corner of the label. The product ingredients section is displayed below the safety instruction section. The plurality of product properties explains all of the resulting properties of the leather cleaning solution upon the use of the leather cleaning solution. The plurality of product properties is displayed as: the surface of the leather article will be cleaned, conditioned, deodorized, and revived. The leather cleaning solution delivers on the plurality of product properties successfully due to the ingredients used in the leather cleaning solution. The product directions section is located in the top right hand corner of the label. The product volume, net weight of 4 oz, is displayed below the plurality of graphics.

### Sodium Hydroxide 1

Sodium Hydroxide 1 is mainly ionic which contains Sodium cations and Hydroxide anions. Hydroxide anion makes Sodium Hydroxide 1 a strong base which reacts with acids to form water and the corresponding salts. Sodium Hydroxide 1, NaOH, is mainly used as an industrial cleaning agent. Sodium Hydroxide 1 can dissolve deposits like grease, oil, and protein based deposits. In the leather cleaning solution, Sodium Hydroxide 1 acts as the main cleaning ingredient without discoloring or damaging the surface of the leather article.

### Ammonium Chloride 2

Ammonium Chloride 2 is used in the textile and leather industry in dyeing, tannin textile printing and to luster cotton. Ammonium Chloride 2 is an inorganic compound with formula NH₄Cl. It is a white crystalline salt that is highly soluble in water and the solution of Ammonium Chloride 2 is mildly acidic. A 5% by weight solution of Ammonium Chloride 2 in water has a pH in the range 4.6 to 6.0. One of the wet leather treatment processes is known as bating. This process is used to remove any residual and cleaning composition present on the leather. Bating is performed in two phases: deliming and actual bating. In the actual bating process, Ammonium Chloride 2 salts are used as one of the ingredient. These Ammonium Chloride 2 salts are added to the soluble compounds which can be washed free. The amounts of components which may be included in the bating composition include from about 30% to about 50% by weight of said salt, from about 1% to about 10% by weight water, and from about 30% to about 50% by weight of alkyl polyglycoside. Ammonium Chloride 2 in the leather cleaning solution is used as leather conditioning agent so the bating process continuous with the uses of the leather cleaning solution. Ammonium compound also acts as a fabric-softening agent so the leather materials will be soft and will not become dry over time. Keeping the moisture within the leather article increases the lifecycle of the leather article.

### Ethylbenzyl 3

The Alkyl Dimethyl Ethylbenzyl Ammonium Chloride solution (Ethylbenzyl 3) is also known as an antimicrobial solution. The Ethylbenzyl 3 will reduce the level of microorganisms on the porous materials. The porous materials can be considered as any kind of leather products. Furthermore, the antimicrobial agent can reduce the surface tension of leather materials so the Ethylbenzyl 3 can increase its effectiveness against any kind of microorganisms which would affect the lifecycle of the products. The Ethylbenzyl 3 is bound to protect leather articles against any kind of fungal attacks but the Ethylbenzyl 3 does not discolor or damage products during the process.

The liquid leather cleaning solution is sprayed onto the surface of the leather article as the first step. After the leather cleaning solution being sprayed onto the leather article, a clean cotton cloth or paper towel is used to wipe off the leather cleaning solution. If the surface of the leather article has a shiny or polished surface, the clean cotton cloth is recommended so the surface will not get damage or scratched. Paper towel can be used in items like basketballs or toys. During the process of the leather cleaning solution is being wiped off from the leather article, it is best to incorporate a circular motion rubbing pattern. The circular motion rubbing pattern can be either clockwise or counter clockwise. The circular motion rubbing pattern will evenly spread the leather cleaning solution over the surface of the leather article. Due to the evenly spread solution, the leather product will be completely cleaned and conditioned. Leather fibers in the article will be revived from the leather cleaning solution and the leather product will be completely sanitized.

Although the invention has been explained in relation to its preferred embodiment, it is to be understood that many other possible modifications and variations can be made without departing from the spirit and scope of the invention as hereinafter claimed.

What is claimed is:

1. A leather cleaning solution comprises compounds selected from the group of sodium hydroxide, ammonium chloride, and ethylbenzyl,
the sodium hydroxide being a main cleaning agent in the leather cleaning solution;
the ammonium chloride being a main moisturizing agent in the leather cleaning solution; and
the ethylbenzyl being a main antibacterial agent in the leather cleaning solution;

2. A method of using a leather cleaning solution comprises the steps of:
mixing the leather cleaning solution by shaking a bottle, wherein the leather cleaning solution is located within the bottle;
evenly spraying the leather cleaning solution onto a leather product with the bottle, wherein the bottle comprises a spray unit;
drying the leather solution of the leather product by wiping the leather product with a clean cloth or a paper towel;
